(19) United States
(12) Patent Application Publication
(10) Pub. No.: US 2014/0032952 A1
(43) Pub. Date: Jan. 30, 2014

(54) ELECTRONIC APPARATUS AND DRIVE CONTROL METHOD THEREOF

(71) Applicant: SAMSUNG ELECTRONICS CO., LTD., Suwon-si (KR)

(72) Inventors: Kun-suk KIM, Suwon-si (KR); Yeong-bok CHOI, Suwon-si (KR)

(73) Assignee: SAMSUNG ELECTRONICS CO., LTD., Suwon-si (KR)

(21) Appl. No.: 13/770,179

(22) Filed: Feb. 19, 2013

(30) Foreign Application Priority Data
Jul. 24, 2012 (KR) 10-2012-0080755

(51) Int. Cl. G06F 1/32

(52) U.S. Cl. CPC G06F 1/3234
USPC 713/323

(57) ABSTRACT

An electronic apparatus includes an input unit to receive a DC electric power from an adapter, a battery unit to store the received DC electric power therein, a first control unit to drive the electronic apparatus by using the electric power of the battery unit or the electric power received from the input unit in a first operation mode, and to drive the electronic apparatus by using both the electric power of the battery unit and the electric power received from the input unit in a second operation mode, and a comparing circuit unit to allow the first control unit to drive the electronic apparatus in a third operation mode having a power consumption lower than the first and second operation modes when the DC electric power input from the adapter is blocked.

### CROSS-REFERENCE TO RELATED APPLICATIONS

This application claims priority under 35 U.S.C. §119(a) from Korean Patent Application No. 10-2012-0080755 filed Jul. 24, 2012 in the Korean Intellectual Property Office, the disclosure of which is incorporated herein by reference in its entirety.

### BACKGROUND OF THE INVENTION

1. Field of the Invention

The present disclosure relates to an electronic apparatus and a drive control method thereof. More particularly, the present disclosure relates to an electronic apparatus that can stably supply an electrical power regardless of whether an adapter is connected to and a drive control method thereof.

2. Description of the Related Art

A notebook computer refers to a computer that has a size of a notebook, and is easy to carry around, and which an individual can use while moving around therewith. Recent notebook computers are provided with processors and graphics performances of which are improved, thereby needing a lot of power consumption. Accordingly, the notebook computer can sufficiently supply an electric power in an adapter mode in which an adapter is connected to the notebook computer. However, in a battery mode in which the adapter is not connected to the notebook computer, because of the limitation of the delivered electric power, the notebook computer operates with a lower electric power than in the adapter mode, thereby preventing the overload of the battery thereof.

However, a conventional notebook computer took a long time to reduce the load of the system in a process of switching from the adapter mode to the battery mode. In a detail, there is a problem that when the adapter is removed from the system in the middle of a task that requires a large power consumption, the battery is momentarily unable to correspond to the large power consumption, and stops supplying the electric power by a self-protection circuitry within the battery so that the system is turned off. Such a problem will be described hereinafter with reference to FIG. 8.

FIG. 8 is a view illustrating current waveforms of a battery of a notebook computer when an adapter is removed from the notebook computer.

When being switched from the adapter mode to the battery mode, a micro computer of the conventional notebook computer receives a signal indicating that the adapter is disconnected therefrom according to a signal ADT3_SEL at a time 1, determines that loads of the processor and graphics should be changed by software, and adjusts the loads of the processor and graphics. When the loads thereof are changed by a software program at a time 1, the notebook computer requires a switching time, for example, about several tens of milliseconds (ms).

In this case, when the adapter is disconnected from the notebook computer that is being used with a sufficiently large load condition in the adapter mode, as illustrated in FIG. 8, the battery temporarily supplies a high electric power as indicated in a portion A due to use of the large loads. For several tens of milliseconds for which the system has been operated in the battery mode, the battery may be overloaded so that the battery protection circuitry may work to sever the electric power of the system.

Also, since the battery is temporarily required to receive large loads, the battery may malfunction so as to shorten the lifespan of the battery. Particularly, since a low capacity of battery is required to receive larger loads, accident may occur in the electronic apparatus.

### SUMMARY OF THE INVENTION

The present disclosure provides an electronic apparatus that can stably supply electric power depending on whether an adapter is connected to and a drive control method thereof.

The present general inventive concept provides am apparatus and method of adjusting a load of a processor, a graphic, etc., by a hardware unit until the system recognizes to be switched to a battery mode when an adapter is disconnected.

Additional features and utilities of the present general inventive concept will be set forth in part in the description which follows and, in part, will be obvious from the description, or may be learned by practice of the general inventive concept.

The foregoing and/or other features and utilities of the present general inventive concept may substantially be achieved by providing an electronic apparatus, which may include an input unit that receives a DC electric power from an adapter, a battery unit that stores the received DC electric power therein, a first control unit that, in a first operation mode, drives the electronic apparatus by using the electric power of the battery unit or the electric power received from the input unit, and, in a second operation mode, drives the electronic apparatus by using both the electric power of the battery unit and the electric power received from the input unit, and a comparing circuit unit that, when the DC electric power input from the adapter is blocked, allows the first control unit to drive the electronic apparatus in a third operation mode having a power consumption lower than the first and second operation modes.

The electronic apparatus may include a second control unit that provides the first control unit with whether the DC electric power is input from the adapter and state information of the battery unit.

After the electronic apparatus is switched to the third operation mode and a predetermined time has elapsed, the second control unit may cause the operation mode of the electronic apparatus to be switched from the third operation mode to the first operation mode.

The second control unit may include a main board chipset.

The electronic apparatus may include a power control unit that detects whether the DC electric power is input from the adapter, and provides a detecting result and the state information of the battery unit to the second control unit.

The power control unit may selectively provide the first control unit with the electric power input through the input unit depending on the operation mode of the electronic apparatus, and may recharge the battery unit by using the electric power being input through the input unit depending on the operation mode of the electronic apparatus and a charge state of the battery unit.

The state information of the battery unit may include at least one of whether the battery unit is mounted to the electronic apparatus and charge state information of the battery unit.

Depending on the state of the battery unit and whether the DC electric power is supplied from the input unit, the power control unit may limit that the electronic apparatus is switched to the second operation mode.

When receiving a control signal for switching from the third operation mode to the first operation mode from the second control unit, the comparing circuit unit may cause the first control unit to operate in from the third operation mode to the first operation mode.

The comparing circuit unit may include an OR gate that receives an adapter connecting information signal from the power control unit, receives a return control signal informing switching from the third operation mode to the first operation mode from the second control unit, performs an OR logical operation on the received adapter connecting information signal and the return control signal, and outputs a result of the OR logical operation; and an AND gate that receives an output signal of the OR gate and a thermal overload information signal of the first control unit from the second control unit, performs an AND logical operation on the output signal of the OR gate and the thermal overload information signal, and outputs a result of the AND logical operation.

The AND gate may provide the result of the AND logical operation to a PROCHOT # port of the first control unit.

In the third operation mode, the first control unit may operate with an operation frequency lower than in the first operation mode.

The first control unit may include at least one of a central processing unit, a graphics processing unit, and a central processing unit having a built-in graphics processing unit.

The first operation mode may be a mode in which the first control unit operates with a first predetermined thermal design power, and the second operation mode may be a mode which the first control unit operates with a second thermal design power higher than the first thermal design power by using both the electric power of the battery unit and the electric power input from the input unit.

The third operation mode may be a mode in which the first control unit operates with a third thermal design power of 80% to 90% of the first thermal design power.

The foregoing and/or other features and utilities of the present general inventive concept may also be achieved by providing a drive control method of an electronic apparatus having a plurality of operation modes, the drive control method including allowing a first control unit to operate in a first operation mode in which the first control unit operates with a first predetermined thermal design power or in a second operation mode in which the first control unit operates with a second predetermined thermal design power, and when a DC electric power provided from an external adapter is blocked, switching to a third operation mode in which the first control unit operates with a third thermal design power lower than the first and second thermal design powers.

The switching to a third operation mode may be performed by providing the first control unit with a signal informing to be operated in the third operation mode without passing through the second control unit.

The drive control method may include after the electronic apparatus is switched to the third operation mode and a predetermined time has elapsed, switching the operation mode of the electronic apparatus from the third operation mode to the first operation mode.

The predetermined time may be a time which the second control unit takes to recognize that the DC electric power input from the adapter is blocked.

In the third operation mode, the first control unit may operate with an operation frequency lower than in the first operation mode.

The foregoing and/or other features and utilities of the present general inventive concept may also be achieved by providing an electronic apparatus with a plurality of operation modes, the electronic apparatus including an input unit to receive a DC electric power from an adapter, a battery unit to store the received DC electric power therein, and a control unit to perform a function with a first power supply corresponding to one of the DC electric power and a charged power of the battery unit in a first operation mode, a second power supply corresponding to both the DC electric power and the charged power of the battery unit in a second operation mode, and a third power supply corresponding to the charged power of the battery unit in a third operation mode, according to a charge state and a mounting state of the battery unit and a connection state of the input unit to the adapter, the third power being lower than the first power and the second power.

The control unit may include one or more sub-control units formed of at least one of a data processing unit and a main board chipset to perform the function according to different clocks with different operation frequencies according to a corresponding one of the first, second, and third modes.

The electronic apparatus may further include a comparing circuit unit having a first port to receive the connection state of the input unit, a second port to receive at least one of the charging state and the mounting state of the battery unit, and an output port to output a comparison result to change among the first, second, and third operation modes.

The control unit may change the third operation mode to the first operation mode a predetermined time after the third operation mode has been set.

### BRIEF DESCRIPTION OF THE DRAWINGS

These and/or other features and utilities of the present general inventive concept will become apparent and more readily appreciated from the following description of the embodiments, taken in conjunction with the accompanying drawings of which:

FIG. 1 is a view illustrating a configuration of an electronic apparatus according to an embodiment of the present disclosure;

FIG. 2 is a view illustrating a detailed configuration of a power unit of the electronic apparatus of FIG. 1;

FIG. 3 is a circuit diagram illustrating an electronic apparatus according to an embodiment of the present disclosure;

FIG. 4 is a detailed circuit diagram illustrating a comparing circuit unit of the electronic apparatus of FIG. 3;

FIG. 5 is a view illustrating an example of an operation mode of a comparing circuit unit of the electronic apparatus of FIG. 3;

FIG. 6 is a view illustrating waveforms of an output voltage of an electronic apparatus according to an embodiment of the present disclosure when an operation mode is switched;

FIG. 7 is a flow chart illustrating a drive control method according to an embodiment of the present disclosure; and

FIG. 8 is a view illustrating current waveforms of a battery of a conventional notebook computer when an adapter thereof is disconnected.

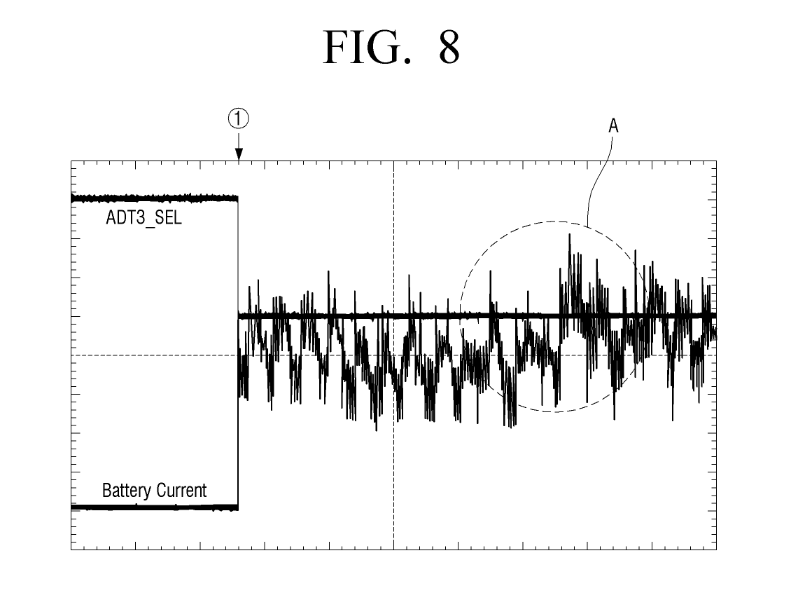

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept while referring to the figures.

The matters defined herein, such as a detailed construction and elements thereof, are provided to assist in a comprehensive understanding of this description. Thus, it is apparent that exemplary embodiments may be carried out without those defined matters. Also, well-known functions or constructions are omitted to provide a clear and concise description of exemplary embodiments. Further, dimensions of various elements in the accompanying drawings may be arbitrarily increased or decreased for assisting in a comprehensive understanding.

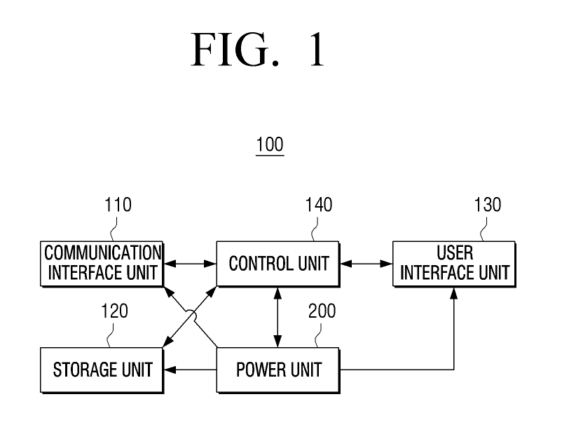

FIG. 1 is a view illustrating a configuration of an electronic apparatus 100 according to an embodiment of the present disclosure.

Referring to FIG. 1, the electronic apparatus 100 may include a communication interface unit 110, a storage unit 120, a user interface unit 130, a control unit 140, and a power unit 200. Here, the electronic apparatus may include notebook computers, tablets, etc. to which a hybrid electric power system may be applied.

The electronic apparatus 100 has a plurality of operation modes. Here, the plurality of operation modes may include a first operation mode (or a normal mode) in which the electronic apparatus 100 operates with a first level of power, for example, a first predetermined thermal design power, a second operation mode (or a turbo mode) in which it operates with a second level of power, for example, a second thermal design power higher than the first thermal design power, and a third operation mode (or a low-power mode) in which it operates with a third level of power, for example, a third thermal design power lower than the first and second thermal design powers. Since the second operation mode operates with the second thermal design power higher than the first thermal design power, the electronic apparatus 100 is supplied with an electric power by a hybrid power system that simultaneously uses an electric power supplied from an adapter and an electric power of a battery.

The communication interface unit 110 is formed to connect the electronic apparatus 100 to external apparatuses, and may be formed to be connected to the external apparatuses by a wireless communication manner (for example, wireless communications such as global system for mobile communication (GSM), universal mobile telecommunication system (UMTS), long term evolution (LTE), wireless broadband (WiBRO), etc) as well as through a local area network (LAN) and the internet network.

The storage unit 120 stores programs for driving the electronic apparatus 100. The storage unit 120 may store programs which are sets of various commands required to drive or operate the electronic apparatus 100 to perform a function thereof. Here, the programs may include not only application programs to provide specific services but also operating programs to drive the application programs. The storage unit 120 may be implemented as a storage medium within the electronic apparatus 100 and an external storage medium, for example, a semiconductor chip unit or semiconductor chip package, a removable disk including a USB memory, a web server through a network, etc.

The user interface unit 130 may have a plurality of function keys that allows a user to set or to select various functions supported by the electronic apparatus 100, and may indicate various information provided by the electronic apparatus 100. The user interface unit 130 may be implemented as an apparatus, such as a touch screen or panel, etc., that can perform input and output at the same time or as an apparatus formed by combining a mouse and a monitor.

The user interface unit 130 may display information with respect to a current operation mode of the electronic apparatus 100. In detail, when the electronic apparatus 100 is switched to the third operation mode, the user interface unit 130 can display information to indicate that the electronic apparatus 100 is switched to the third operation mode. Also, when the electronic apparatus 100 is switched to the second operation mode, the user interface unit 130 can display information to indicate that the electronic apparatus 100 is switched to the second operation mode and operation time of the second operation mode. Here, the third operation mode is an operation mode that consumes an electric power lower than those of the first and second operation modes.

Then, the user interface unit 130 may display information with respect to a state of the electric power. In detail, the user interface unit 130 may display electric power state information about whether the adapter is connected, whether a battery is mounted, a state of charge of the battery unit, etc. for the users.

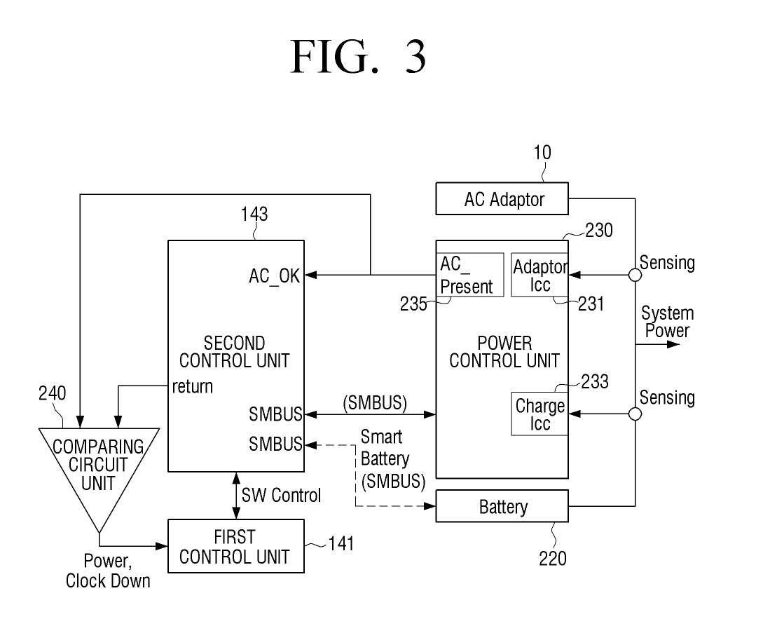

The control unit 140 performs control each configuration within the electronic apparatus 100. The control unit 140 may be implemented as a first control unit 141 and a second control unit 143 as illustrated in FIG. 3. Here, the first control unit 141 may be anyone of a central processing unit, a graphics processing unit, and a central processing unit having a built-in graphics processing unit. The first control unit 141 and the second control unit 143 may be a functional unit of the electronic apparatus to perform a function thereof. The function may be include, but not limited to, processing data, displaying an image corresponding to the processed data, photographing and processing image data, reproducing data, or communicating with an external device to transmit or receive data to generate video and/or sound data or output processed data. The functional unit may include electrical and/or mechanical components to perform the function thereof. The second control unit 143 may be a main board chipset to control the electronic apparatus or to control the first control unit 141. Detailed configuration and operation of the first and second control units 141 and 143 will be explained later with reference to FIG. 3.

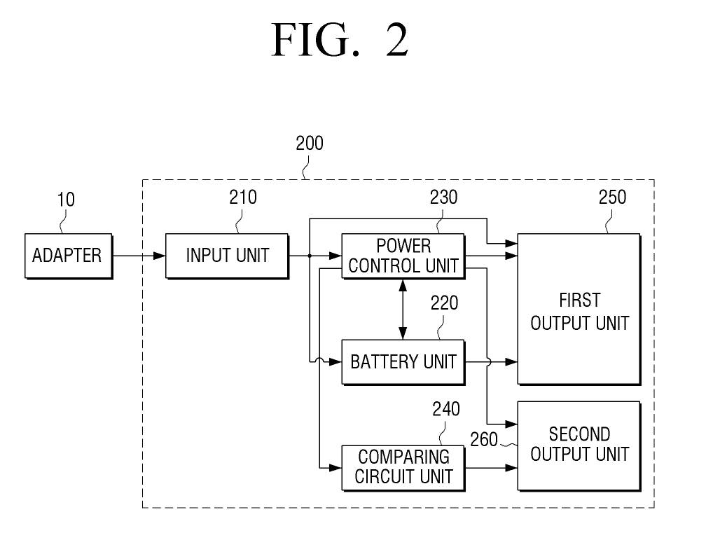

The power unit 200 supplies the electric power to each of configurations included in the electronic apparatus 100. Detailed configuration and operation of the power unit 200 will be explained hereinafter with reference to FIG. 2.

FIG. 2 is a view illustrating a detailed configuration of the power unit 200 of the electronic apparatus 100 of FIG. 1 according to an embodiment of the present general inventive concept.

Referring to FIG. 2, the power unit 200 may include an input unit 210, a battery unit 220, a power control unit 230, a comparing circuit unit 240, a first output unit 250, and a second output unit 260.

The input unit 210 receives a DC electric power from an external adapter 10.

The battery unit 220 stores the received DC electric power therein. The battery unit 220 may include a secondary battery, and can recharge the secondary battery with the DC electric power received through the input unit 210. Here, the secondary battery may include nickel batteries, cadmium batteries, nickel-cadmium batteries, nickel-metal hydride batteries, lithium-ion batteries, lithium-ion polymer batteries, etc. The battery unit 220 may include a primary battery, and may supply power at least one of the primary battery and the second battery to a corresponding configuration (unit or element) of the electronic apparatus 100. The battery unit 220 can supply the electric power to each configuration within the electronic apparatus 100.

The power control unit 230 detects whether the DC electric power is input from the adapter, and provides the control unit 140 (i.e., the second control unit 143) with the detecting result and the state information of the battery unit 220. The power control unit 230 may detect a voltage value of the DC electric power that is input through the input unit 210, and when the detected voltage value of the DC electric power becomes lower than a predetermined value, the power control unit 230 may determine that no DC electric power is input from the adapter 10.

Then, the power control unit 230 may recharge the battery unit 220 by using the electric power being input through the input unit 210 depending on an operation mode of the electronic apparatus 100 and the charge state of the battery unit 220. When the electronic apparatus 100 operates in the first operation mode (i.e., when it operates in operation modes other than the second operation mode) and receives the DC electric power through the input unit 210, the power control unit 230 can use the DC electric power input through the input unit 210 in order to recharge the battery unit 220.

Then, when the operation mode of the electronic apparatus 100 is the second operation mode, or when the battery unit 220 is a full charge state (or a complete charge state), the power control unit 230 may not cause the battery unit 220 to be recharged even when the DC electric power is input through the input unit 210.

Then, depending on the operation mode of the electronic apparatus 100, the power control unit 230 may selectively provide the first control unit 141 with the electric power input through the input unit 210. When the electronic apparatus 100 operates in the second operation mode, the power control unit 230 may allow both the electric power being input through the input unit 210 and the electric power of the battery unit 220 to be supplied to the first control unit 141. In other words, in the second operation mode, the power control unit 230 may control each configuration within the power unit 200 so that the first control unit 141 is supplied with the electric power as a hybrid electric power system.

Then, the power control unit 230 may limit the electronic apparatus 100 to be switched to the second operation mode depending on the state of the battery unit 220 power control unit 230 detects the charge state and mounting state of the battery unit 220, and when the detected charge state is less than a predetermined capacity or when the battery unit 220 is not mounted to the electronic apparatus 100, the power control unit 230 may limit or prevent the electronic apparatus 100 to be switched to the second operation mode. In the present embodiment, the power control unit 230 may limit or prevent the electronic apparatus 100 to be switched to the second operation mode. However, the present general inventive concept is not limited thereto. It is possible that such a function may be implemented to be performed by the first control unit 141 or the second control unit 143 as described later.

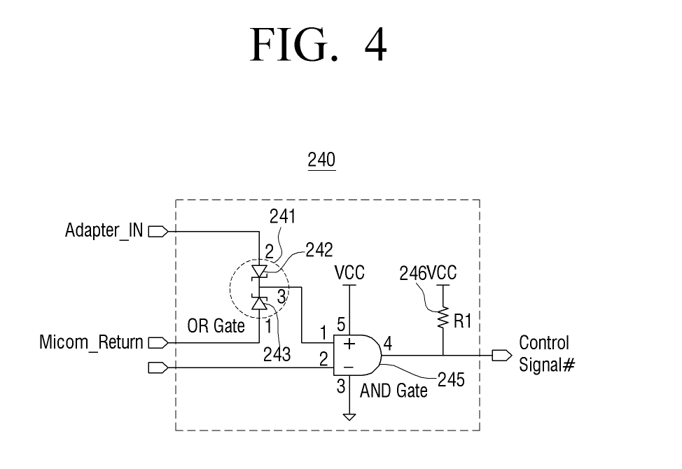

If the DC electric power being input from the adapter 10 is blocked, the comparing circuit unit 240 causes the first control unit 141 to operate in the third operation mode that operates with a power consumption lower than that of the first operation mode and the second operation mode. Then, when receiving a control signal to switch from the third operation mode to the first operation mode from the second control unit 143, the comparing circuit unit 240 causes the first control unit 141 to operate in the first operation mode. Detailed configuration and operation of the comparing circuit unit 240 will be described later with reference to FIG. 4.

The first output unit 250 supplies the electric power to each configuration within the electronic apparatus 100. When the electronic apparatus 100 operates in the first operation mode, the first output unit 250 selectively supplies the electric power input through the input unit 210 or the electric power of the battery unit 220 to each configuration within the electronic apparatus 100.

When the electronic apparatus 100 operates in the second operation mode, the first output unit 250 may supply both the electric power input through the input unit 210 and the electric power of the battery unit 220 to the control unit 140.

Then, when the electronic apparatus 100 operates in the third operation mode, the first output unit 250 may supply the electric power of the battery unit 220 to each configuration within the electronic apparatus 100.

According to the present embodiment, the electric power is supplied to each configuration within the electronic apparatus 100 through the single first output unit 250. However, the present general inventive concept is not limited thereto. It is possible that the electric power is supplied to each configuration within the electronic apparatus 100 through a plurality of output units.

The second output unit 260 may provide the control unit 140 with information about the states of the battery unit 220 and the input unit 210.

Then, the second output unit 260 provides the control unit 140 (i.e., the first control unit 141) with a control signal to inform that the first control unit 141 should be switched to the third operation mode. In the present embodiment, various information may be provided to the control unit 140 through the second output unit 260. However, the present genera inventive concept is not limited thereto. It is possible that various information can be directly provided to the control unit 140, that is, each of output signals of the power control unit 230 and the comparing circuit unit 240 is directly provided to the first control unit 141 or the second control unit 143.

The configuration of the electronic apparatus 100 may receive different power supplies from the power control unit 230 according to the operation mode such that the configuration may selectively perform a function to correspond to the receive power supply. The configuration may be a circuit or processor unit to perform at least one of functions for different power consumption. The configuration may have sub-configurations to correspond to the respective different power supplies. It is also possible that the configuration can perform a function with clock signals of different operation frequencies relating to different power consumptions. The configuration may be the first control unit 141 and the second control unit 143. However, the present general inventive concept is not limited thereto. It is possible that other units or elements or other circuits or processor can be the configuration to perform at least a portion of the function thereof.

FIG. 3 is a circuit diagram illustrating an electronic apparatus 100 according to an embodiment of the present disclosure.

Referring to FIG. 3, the electronic apparatus 100 may include a battery unit 220, a power control unit 230, a comparing circuit unit 240, a first control unit 141, and a second control unit 143.

The first control unit 141 may be anyone of a central processing unit, a graphics processing unit, and a central processing unit having a built-in graphics processing unit to perform a function of the electronic apparatus 100.

Then, the first control unit 141 may determine the operation mode of the electronic apparatus 100. The first control unit 141 may normally control the electronic apparatus 100 to operate in the first operation mode. When a high load is required, the first control unit 141 may control the electronic apparatus 100 to operate in the second operation mode. When a load reduction is required, the first control unit 141 may control the electronic apparatus 100 to operate in the third operation mode.

At this time, the first control unit 141 may determine whether to be switched to the second operation mode based on the states of the battery unit 220 and the input unit 210. As described above, since when operating in the second operation mode, the electronic apparatus 100 is supplied with the electric power from the hybrid electrical power system using at the same time the electric power of the adapter 10 and the electric power of the battery unit 220, if the battery unit 220 is not mounted to the electronic apparatus 100 or if the battery unit 220 has the charging capacity less than the predetermined capacity, an excess of the rated power may occur in the adapter 10. Therefore, only when the battery unit 220 is mounted to the electronic apparatus 100, the charge capacity of the battery unit 220 is greater than the predetermined capacity, and the DC electric power is supplied through the input unit 210, the first control unit 141 may switch the operation mode of the electronic apparatus 100 from the first operation mode to the second operation mode.

Then, even when it is determined that a status requires a high load, if the battery unit 220 is not mounted to the electronic apparatus 100 or if the battery unit 220 is mounted to the electronic apparatus 100 but the charge capacity of the battery unit 220 is less than the predetermined capacity and the DC electric power is not supplied through the input unit 210, the first control unit 141 may limit or prevent switching to the second operation mode.

Then, after the status requiring the high load is terminated, or after the operation in the second operation mode is maintained over a predetermined period of time, the first control unit 141 may cause the operation mode of the electronic apparatus 100 to be switched from the second operation mode to the first operation mode.

Then, when the comparing circuit unit 240 outputs information to inform that switching to the third operation mode is needed according to input signals received from the power control unit 230 and the second control unit 143, in order to control the first control unit 141 to operate in the third operation mode, the first control unit 141 may operate with an operation frequency lower than that of the first operation mode. The output of the comparing circuit unit 240 may be a signal to control power to be consumed and/or an operation frequency (clock signal) to be controlled. When the adapter 10 is blocked or is not connected and a control signal is input from the comparing circuit unit 240 to an input port of the first control unit 141 during an operation in the first and second operation modes, the first control unit 141 can operate with the operation frequency lower than that of the first operation mode. Here, the third operation mode is an operation mode in which the first control unit 141 operates about 80-90% performance compared to the performance of the first control unit 141 in the first operation mode. It is possible that the first control unit 141 may operate with an operation frequency in the third operation mode lower than the operation frequency of the first operation mode, operate with a lower level of power, or operate with selected ones of functions thereof, to correspond to the reduced performance.

Then, after the electronic apparatus 100 is switched to the third operation mode and a predetermined time has elapsed, the first control unit 141 may cause the electronic apparatus 100 to be switched from the third operation mode to the first operation mode. When a return signal informing that switching to the first operation mode is required is generated in the second control unit 143 so that an output signal of the comparing circuit unit 240 is converted into a low state, the first control unit 141 may operate with an operation frequency higher than that of the third operation mode and lower than that of the second operation mode.

On the other hand, as described above, the first control unit 141 may receive information about the states of the battery unit 220 and input unit 210 from the second control unit 143 to determine the operation mode of the electronic apparatus 100.However, the present general inventive concept is not limited thereto. It is possible that the second control unit 143 receives information about a load state from the first control unit 141 and determines the operation mode of the electronic apparatus 100. The first control unit 141 and the second control unit 142 may communicate with each other through a line SW Control to transmit and receive information thereof.

The second control unit 143 may receive information about the states of the battery unit 220 and the input unit 210 from the power control unit 230 through terminals of SMBUS and AC_OK, and may provide the received information about the states of the battery unit 220 and the input unit 210 to the first control unit 141. The second control unit 143 may be a main board chipset.

The main board chipset may include one or more semiconductor chips or one or more semiconductor chip packages which can be operated with a high-speed and/or a slower speed to perform a function of the electronic apparatus 100.

The first control unit 141 and/or the second control unit 143 may be selectively operated with the high-speed and high power consumption or the slower speed and low power consumption according to the operation mode.

When the DC electric power is blocked to be input from the adapter 10 and a predetermined time has elapsed, the second control unit 143 may control the first control unit 141 for the electronic apparatus 100 to be switched to the first operation mode. The second control unit 143 recognizes by a software program that the DC electric power is blocked to be input from the adapter 10. As described above, due to recognition by a software program at a time when the second control unit 143 recognizes that the DC electric power input from the adaptor 10 is blocked, the electronic apparatus 100 has been switched to the third operation mode by the operation of the comparing circuit unit 240 that is operated by a hardware component or device. Accordingly, the load of the first control unit 141 is reduced, and in order to normally restore the power and performance of a system thereof that had been artificially reduced, the second control unit 143 may output a return signal through a port “return” to the comparing circuit unit 240 for the electronic apparatus 100 to operate in the first operation mode. Accordingly, the predetermined time as described above may be a time taken by the second control unit 143 to recognize that the DC electric power input from the adaptor 10 is blocked. Alternatively, the predetermined time may be a time that is the time taken by the second control unit 143 to recognize plus an extra time given according to a design selection or user preference in order to stabilize the system thereof.

The power control unit 230 may include an adapter voltage detecting element 231, a charge voltage detecting element 233, and an adapter information output element 235.

The adapter voltage detecting element 231 may detect a voltage size or level (and/or a current size or level) of the electric power input through the input unit 210. The adapter voltage detecting element 231 can detect a voltage value (and/or a current value) of the electric power input through the input unit 210 by using an external resistor.

Then, the adapter voltage detecting element 231 may determine whether the adapter 10 is connected (namely, whether the DC electric power is input through the input unit 210) based on the detected voltage value (and/or the current value), and may provide the second control unit 143 and comparing circuit unit 240 with the determination result as an adapter connecting information signal through the adapter information output element 235. In the present embodiment, only the determination result is provided to the second control unit 143 and the comparing circuit unit 240. However, the present general inventive concept is not limited thereto. It is possible that the detected voltage size or level can be provided to the second control unit 143.

The charge voltage detecting element 233 may detect a size or level of the voltage (and/or the current) that is being supplied to the battery unit 220. The charge voltage detecting element 233 can detect a charge voltage value of the electric power being supplied to the battery unit 220, and can provide the detected charge voltage value to the second control unit 143. Although the present embodiment illustrates that the detected charge voltage value is provided to the second control unit 143, it may be implemented that only whether the detected charge voltage value is within a predetermined range is provided to the second control unit 143.

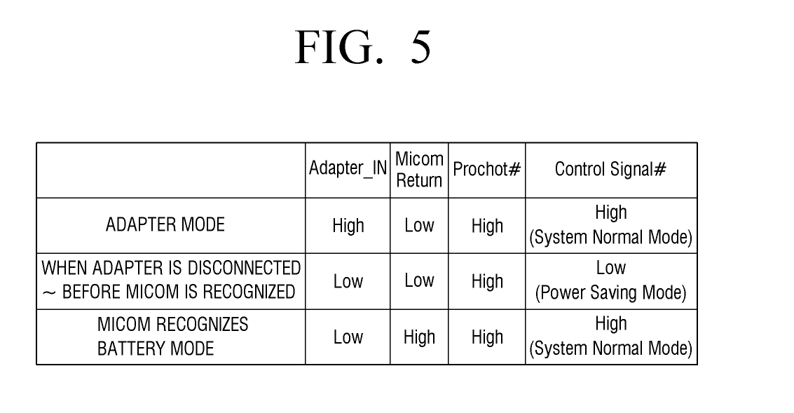

If the DC electric power is blocked to be input from the adapter 10, the comparing circuit unit 240 directly provides, by a hardware method, the first control unit 141 with a signal informing that corresponding configuration of the electronic apparatus 100 needs to be operated in the third operation mode. Therefore, when at least one corresponding configuration of the electronic apparatus 100 may be in the operation mode, corresponding power is supplied to the corresponding configuration of the electronic apparatus 100, through the first output unit 250 and/or the second output unit 260, for example, and the first control unit 141 and the second control unit 143 may operate accordingly. The operation state of the comparing circuit unit 240 is illustrated in FIG. 5. Detail configuration of the comparing circuit unit 240 will be explained hereinafter with reference to FIG. 4.

FIG. 4 is a detailed circuit diagram illustrating the comparing circuit unit 240 of FIG. 3.

Referring to FIG. 4, the comparing circuit unit 240 may include an OR gate 241 and an AND gate 245.

The OR gate 241 receives an adapter connecting information signal Adapter_IN from the power control unit 230, receives a return control signal Micom_Return to inform switching from the third operation mode to the first operation mode from the second control unit 143, performs an OR logical operation on the received adapter connecting information signal Adapter_IN and return control signal Micom_Return, and outputs the result of the OR logical operation to an input of the AND gate 245. The OR gate 241 may be implemented by a first diode 242 that receives and outputs the connecting information signal Adapter_IN and a second diode 243 that receives and outputs the return control signal Micom_Return. Although in the present embodiment, the OR gate 241 is implemented by using two second diodes, it is possible that the OR gate 241 may be implemented by using an OR logic device. The first diode 241 and second diode 242 may be a Zener diode.

The AND gate 245 receives an output signal of the OR gate 241 and a thermal overload information signal of the first control unit 141 from the second control unit 143, performs an AND logical operation on the received output signal of the OR gate 241 and thermal overload information signal, and outputs the result of the AND logical operation as a control signal. The AND gate 245 provides the AND logical operation result to a port Prochot # of the first control unit 141 to cause the first control unit 141 to operate in the third operation mode. Here, the thermal overload information signal is a signal that is output when a temperature of the first control unit 141 is greater than a predetermined temperature, and may be output by a separate temperature device. It is possible that the thermal overload information signal may be a signal which the second control unit 143 receives temperature information from a temperature sensor of the first control unit 141, and when the received temperature information is higher than the predetermined temperature, the second control unit 143 outputs the thermal overload information signal.

Referring to FIG. 5, in an adapter mode, the control signal may be a high state signal to indicate a system normal mode according to a high signal of Adapter_IN, a low signal of Micom-Return, and a high signal of Prochot. When adapter 10 is disconnected and/or before a corresponding unit is recognized, the control signal may be a low state signal to indicate a power saving mode according to a low signal of Adapter_IN, a low signal of Micom-Return, and a high signal of Prochot. When a corresponding unit recognizes a battery mode, the control signal may be a high state signal to indicate a system normal mode according to a low signal of Adapter_IN, a high signal of Micom-Return, and a high signal of Prochot.

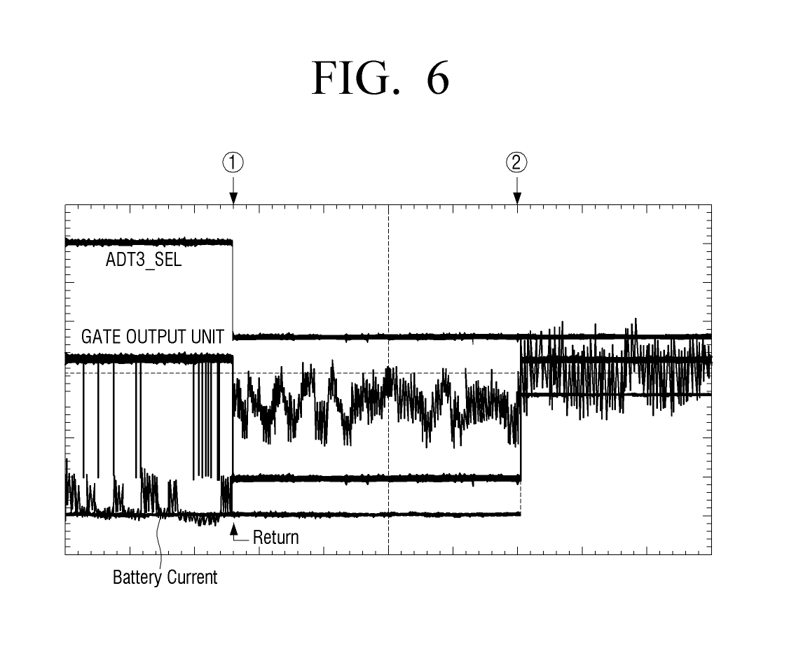

As described above, in the present embodiment, when the adapter 10 is disconnected, the operation mode of the electronic apparatus can be quickly switched to the third operation mode having the lower power consumption by using the separate comparing circuit unit implemented by hardware. The effects of the present disclosure will be described hereinafter with reference to FIG. 6.

FIG. 6 is a view illustrating waveforms of an output voltage of the electronic apparatus 100 of FIG. 1 according to an embodiment of the present disclosure when an operation mode is switched.

Here, before a point “1”, the electronic apparatus 100 operates in the second operation mode using both the electric power of the adapter 10 and the electric power of the battery unit 220, after the point “1” because the adapter 10 does not provide the DC electric power, the electronic apparatus 100 operates with only the electric power of the battery unit 220, and a point “2” is a point in a time when the second control unit 143 recognizes that the DC electric power provided from the adapter 10 is blocked and outputs a return signal.

Referring to FIG. 6, the operation mode of the electronic apparatus 100 may be changed from the second operation mode to the third operation mode and then to the first operation mode. Since at the time when the adapter 10 is disconnected, the output signal of the comparing circuit unit 240 is changed into a low level state, the output current of the battery unit 220 remains lower than the output current of the first operation mode.

After the third operation mode is maintained for a predetermined period of time, the output current of the battery unit 220 is changed into the state higher than the output current of the third operation mode by the return signal.

As described above, at the time when the adapter 10 is disconnected, the power consumption of the first control unit 141 may be quickly reduced by hardware. Therefore, overload of the battery may be prevented.

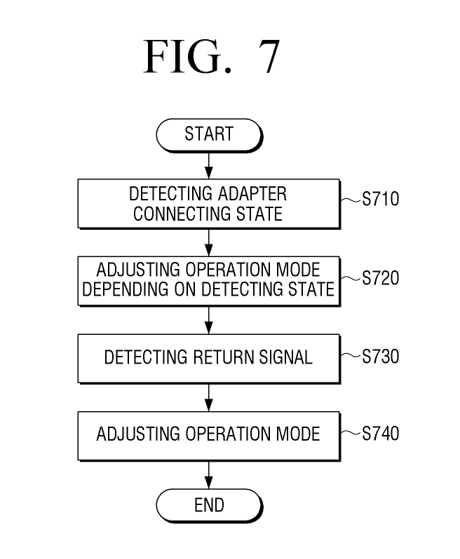

FIG. 7 is a flow chart illustrating an electric power supply method of an electronic apparatus according to an embodiment of the present disclosure.

Referring to FIG. 7, the electronic apparatus is operating in a first operation mode in which it operates with a first predetermined thermal design power or a second operation mode in which it operates with a second predetermined thermal design power.

While operating in the first operation mode or in the second operation mode, the electronic apparatus determines a connecting state of the adapter at operation S710.

Then, when the DC electric power provided from the external adapter is blocked, the electronic apparatus is switched to the third operation mode in which it operates with the third thermal design power lower than the first and second thermal design powers at operation S720. When the DC electric power provided from the external adapter is blocked, a signal informing that the electronic apparatus should be operated in the third operation mode can be directly provided to the first control unit without passing through the second control unit. At this time, the first control unit operates with a driving frequency lower than that of the first operation mode.

Then, the electronic apparatus detects whether a predetermined period of time is passed after it was switched to the third operation mode at operation S730. In detail, when the second control unit recognizes that input of the DC electric power from the adapter is blocked, the second control unit may output a return signal.

When the return signal is output, the operation mode of the electronic apparatus is switched from the third operation mode to the first operation mode at operation S740.

Accordingly, the drive control method according to the present embodiment can stably supply the electric power to the electronic apparatus 100, and, even when the adapter is disconnected, can adjust the load of the system by using a relatively simple circuit configuration. The drive control method as illustrated in FIG. 7 may be executed in an electronic apparatus having the configuration as illustrated in FIG. 1. Alternatively, it may be executed in electronic apparatuses having other configurations.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An electronic apparatus with a plurality of operation modes, the electronic apparatus comprising:
an input unit to receive a DC electric power from an adapter;
a battery unit to store the received DC electric power therein;
a first control unit to drive the electronic apparatus by using the electric power of the battery unit or the electric power received from the input unit in a first operation mode, and to drive the electronic apparatus by using both the electric power of the battery unit and the electric power received from the input unit in a second operation mode; and
a comparing circuit unit to allow the first control unit to drive the electronic apparatus in a third operation mode having a power consumption lower than the first and second operation modes when the DC electric power input from the adapter is blocked.

2. The electronic apparatus of claim 1, further comprising:
a second control unit to provide the first control unit with whether the DC electric power is input from the adapter and state information of the battery unit.

3. The electronic apparatus of claim 2, wherein the second control unit causes the operation mode of the electronic apparatus to be switched from the third operation mode to the first operation mode after the electronic apparatus is switched to the third operation mode and a predetermined time has elapsed.

4. The electronic apparatus of claim 2, wherein the second control unit comprises a main board chipset.

5. The electronic apparatus of claim 2, further comprising:
a power control unit that detects whether the DC electric power is input from the adapter, and provides a detecting result and the state information of the battery unit to the second control unit.

6. The electronic apparatus of claim 5, wherein the power control unit selectively provides the first control unit with the electric power input through the input unit depending on the operation mode of the electronic apparatus, and recharges the battery unit by using the electric power being input through the input unit depending on the operation mode of the electronic apparatus and a charge state of the battery unit.

7. The electronic apparatus of claim 5, wherein the state information of the battery unit comprises at least one of mounting state information of the battery unit to the electronic apparatus and charge state information of the battery unit.

8. The electronic apparatus of claim 5, wherein the power control unit limits that the electronic apparatus is switched to the second operation mode depending on the state of the battery unit and whether the DC electric power is supplied from the input unit.

9. The electronic apparatus of claim 5, wherein the comparing circuit unit causes the first control unit to operate in from the third operation mode to the first operation mode when receiving a control signal for switching from the third operation mode to the first operation mode from the second control unit.

10. The electronic apparatus of claim 5, wherein the comparing circuit unit comprises:
an OR gate to receive an adapter connecting information signal from the power control unit, to receive a return control signal informing switching from the third operation mode to the first operation mode from the second control unit, to perform an OR logical operation on the received adapter connecting information signal and the return control signal, and to output a result of the OR logical operation; and
an AND gate to receive an output signal of the OR gate and a thermal overload information signal of the first control unit from the second control unit, to perform an AND logical operation on the output signal of the OR gate and the thermal overload information signal, and to output a result of the AND logical operation.

11. The electronic apparatus of claim 10, wherein the AND gate provides the result of the AND logical operation to a PROCHOT # port of the first control unit.

12. The electronic apparatus of claim 1, wherein the first control unit operates with an operation frequency lower than in the first operation mode in the third operation mode.

13. The electronic apparatus of claim 1, wherein the first control unit comprises at least one of a central processing unit, a graphics processing unit, and a central processing unit having a built-in graphics processing unit.

14. The electronic apparatus of claim 1, wherein:
the first operation mode is a mode in which the first control unit operates with a first predetermined thermal design power; and
the second operation mode is a mode which the first control unit operates with a second thermal design power higher than the first thermal design power by using both the electric power of the battery unit and the electric power input from the input unit.

15. The electronic apparatus of claim 14, wherein the third operation mode is a mode in which the first control unit operates with a third thermal design power of a performance lower than that of the first thermal design power.

16. A drive control method of an electronic apparatus having a plurality of operation modes, the drive control method comprising:
allowing a first control unit to operate in a first operation mode in which the first control unit operates with a first predetermined thermal design power or in a second operation mode in which the first control unit operates with a second predetermined thermal design power; and
switching to a third operation mode in which the first control unit operates with a third thermal design power lower than the first and second thermal design powers when a DC electric power provided from an external adapter is blocked.

17. The drive control method of claim 16, wherein the switching to the third operation mode is performed by providing the first control unit with a signal informing to be operated in the third operation mode without passing through the second control unit.

18. The drive control method of claim 16, further comprising:
switching the operation mode of the electronic apparatus from the third operation mode to the first operation mode after the electronic apparatus is switched to the third operation mode and a predetermined time has elapsed.

19. The drive control method of claim 18, wherein the predetermined time is a time which the second control unit takes to recognize that the DC electric power input from the adapter is blocked.

20. The drive control method of claim 16, wherein the first control unit operates with an operation frequency lower than in the first operation mode in the third operation mode.
